(19) United States
(12) Patent Application Publication
(10) Pub. No.: US 2018/0114411 A1
(43) Pub. Date: Apr. 26, 2018

(54) ONE CARD TWENTY ONE

(71) Applicants: Frank Preston Machock, SR., Richmond, TX (US); John C. Chase, Houston, TX (US); Robert H. Burnie, San Antonio, TX (US)

(72) Inventors: Frank Preston Machock, SR., Richmond, TX (US); John C. Chase, Houston, TX (US); Robert H. Burnie, San Antonio, TX (US)

(21) Appl. No.: 15/789,326

(22) Filed: Oct. 20, 2017

Related U.S. Application Data
(60) Provisional application No. 62/411,955, filed on Oct. 24, 2016.

(51) Int. Cl. G07F 17/32

(52) U.S. Cl. CPC G07F 17/3293; A63F 2001/003

(57) ABSTRACT

A computer code on a non-transitory computer readable medium for use in a computer for facilitating a method of playing a card game. In response to receiving a wager from a player, the method includes the step of randomly dealing a player's hand including a face card having a value of 10 and one card having a corresponding point value associated the one card in a standard deck. After dealing the player's hand, the method includes the step of randomly dealing two cards to a dealer from among cards remaining in at least one standard deck. Next, a total point value of the dealer's cards is compared to a predetermined threshold. In response to the total point value of the dealer's cards meeting or exceeding the predetermined threshold, the total point value of the dealer's hand is compared to a total point value of the player's hand. In response to the total point value of the dealer's hand being greater than the total point value of the player's hand, an amount corresponding to the wager is reallocated to the dealer. In response to the total point value of the dealer's hand being less than the total point value of the player's hand, a payout is provided to the player.

### CROSS REFERENCE TO RELATED APPLICATIONS

The present application claims the priority benefit of U.S. Provisional Patent Application Ser. No. 62/411,955, filed Oct. 24, 2016, the disclosure of which is fully incorporated herein by reference.

### BACKGROUND

The present disclosure relates to a card game and to systems and game tables for playing the same. The card game allows for more hands per hour to be dealt to players when compared to known Blackjack (twenty-one).

Casino blackjack is a card game between a dealer and players well known in the art. FIG. 1 is a flowchart illustrating the game of blackjack according to the PRIOR ART. The game is played with one or more standard decks of cards. The game starts at S10, when a player makes a main wager by placing chips on a table. At S12, the dealer deals two initial cards to each player (either face up or face down) and two initial cards to the dealer, typically one face down and one face up (the “up-card”). Next, the player can decide whether to hit (add another card to its hand), stand (refuse another card), double (the bet), or split (pairs to make more hands), normally by adding the point total of its two cards. Point totals are computed by adding the standard rank value of each card, with face valued cards (tens, jacks, queens, kings) being given a value of 10, and aces being given a value of 1 or 11, whichever results in a better hand. A soft point total is where at least one ace is given the value of 11. A hard point total is a hand with all aces counting as 1. The player wants its cards to add up to as close to 21 as possible without going over.

In response to the player opting to hit (HIT at S14), an additional card is dealt to the player at S16. The cards are added and the computed total is compared to a threshold value of 21. In response to the player's hard point total being over 21 (YES at S10), the player has busted and loses its main wager at S20, which ends the game for that player. The dealer (or house) takes the wager. If the player has not busted (NO at S10), the method returns to S14, where the player can make another decision on whether to hit or stand. At S14, the player can also double its wager by placing an additional wager of up to the main wager, but the player is limited to drawing only one additional card before the player must stand.

If the player has not busted out (either stands on his or her initial two cards or draws cards but has a point total under 22) (STAND at S14), then the dealer's hand is dealt at S22 according to predetermined rules. The dealer's hand is dealt after all the players receive their hands. In response to the dealer's total being greater than a predetermined amount (typically 17) (YES at S24), the dealer stands and the game proceeds to S32). In response to the dealer's total being less than the predetermined amount (NO at S24), an additional card is dealt to the dealer at S26. If the dealer has not busted (NO at S28), the method returns to S24 and repeats. If the dealer has busted (YES at S30), then the player wins the game and double the main wager at S30.

If both the player and the dealer have played out their hand and neither have busted, their point totals are compared at S32. If the dealer's point total is lower than the player's point total (YES at S34), then the player wins the game and double the main wager (a return of its wager and a payout equal to its wager) at S30. If the dealer's point total is greater than the player's point total (NO at S34 and YES at S38), then the player loses the game and the main wager at S40. If the player's point total ties the dealer's point total (NO at S34 and NO at S38), then that results in a “push” at S36 in which the player doesn't win or lose the main wager (the main wager bet is a wash).

If a player is initially dealt two identically ranked cards at S12, players can also split by placing an additional split wager equal in value to the main wager, and the player's two initial cards are separated and the dealer deals an additional card on each. The player then plays out each of the two separate hands at S14. Depending on house rules, players may or may not be allowed to re-split cards.

Players of the standard Blackjack game have the option of making an “insurance” wager when the dealer's up-card is an ace. If the player makes the insurance wager, the player is betting that the dealer has blackjack (i.e., the dealer's hole card is a ten valued card), and if it turns out to be a ten valued card, the player wins 3:2 on the insurance wager, otherwise the player loses.

Blackjack takes skill, particularly because players must make a decision on every card that is dealt to them. Different players take a different approach on when to hit, stand, split or double on their hand for reaching 21. Some potential gamblers are reluctant to play Blackjack because they are intimidated by the decision making process. In other words, they are less likely to play blackjack over other games. There is desired a variation of the card game known as twenty-one, including different types of bets that players can make in various situations. What is also needed is an alternative card game that allows a player to create betting situations that previously did not exist. At the same time, a card game is desired which balances the dealers' interests with the players' interests. Therefore, a card game is desired which allows more hands to be dealt per hour when compared to standard Blackjack and which does not decrease the standard house edge of existing Blackjack games.

### BRIEF DESCRIPTION

One embodiment of the disclosure is directed to computer code on a non-transitory computer readable medium for use in a computer for facilitating a method of playing a card game. In response to receiving a wager from an associated player, the method includes the step of randomly dealing a player's hand including a card having a value of 10 and a single card having a corresponding number value associated with the card in a standard deck. After dealing the player's hand, the method includes the step of dealing two cards to a user from among cards remaining in at least one standard deck. Next, a total point value of the user's cards is compared to a predetermined threshold. In response to the total point value of the user's cards meeting or exceeding the predetermined threshold, the total point value of the user's hand is compared to a total point value of the player's hand. In response to the total point value of the user's hand being greater than the total point value of the player's hand, an amount corresponding to the wager is reallocated to the user. In response to the total point value of the user's hand being less than the total point value of the player's hand, a payout is provided to the player. Another embodiment of the disclosure is directed to a system for performing the method disclosed supra.

In some embodiments, the deck of cards may comprise at least one physical deck of cards, and a gaming table may be a physical gaming table instead of a console or machine.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart of a method of wagering on a standard PRIOR ART blackjack game;

FIGS. 2A-2B include a flowchart of a method of playing a card game according to an aspect of the present disclosure;

FIG. 3 illustrates a functional block diagram of a playing card system in accordance with one embodiment of the present disclosure;

FIG. 4 illustrates a functional block diagram of a user (player) device in accordance with one embodiment of the present disclosure;

FIG. 5 illustrates a diagram of a user (player) device utilizing the playing card system in accordance with one embodiment of the present disclosure;

FIG. 6 illustrates a diagram of a physical gaming table in accordance with another embodiment of the present disclosure.

### DETAILED DESCRIPTION

Reference will now be made in detail to the exemplary embodiments of the invention, examples of which are illustrated in the accompanying drawings.

The present inventive concept relates to a method and system to implement a card game that varies from standard twenty-one (also known as Blackjack). The card game contemplated herein can be played with at least one standard deck and types of cards commonly used in blackjack.

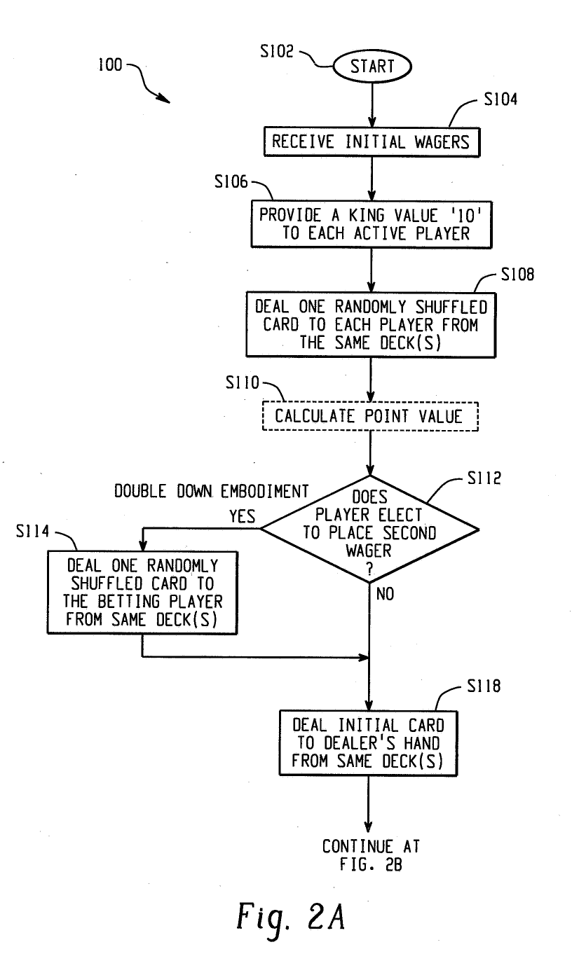

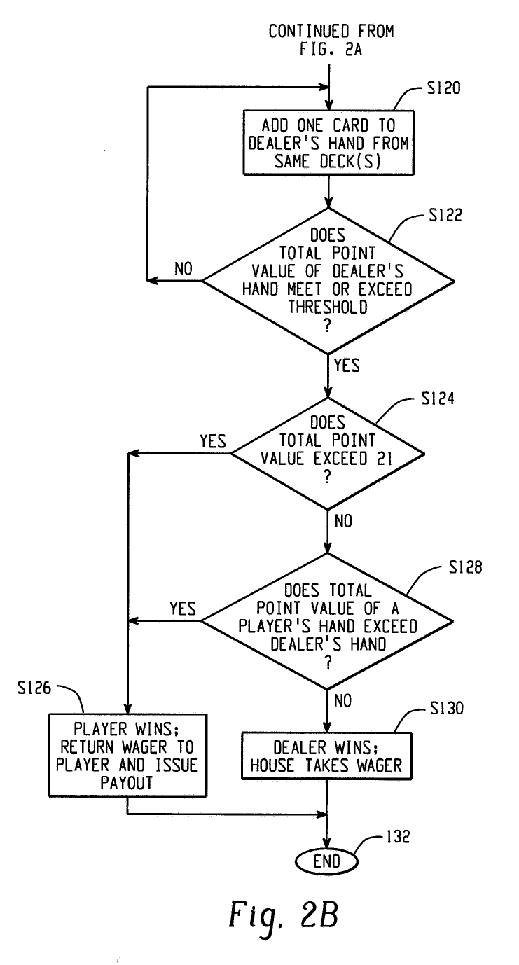

FIG. 2 illustrates a flowchart describing the game according to various embodiments of the present disclosure. The game can be played on a gaming table. However, the disclosure contemplates the game being played on a computerized gaming machine or computer device, which will be described in detail infra, whereby the operations set forth below are performed by a system including the computer. Generally, the cards are dealt such that each player placing a bet receives one card and one card only. The method 100 begins at S102, wherein at least one deck of cards is shuffled or randomly organized. In particular embodiments, the deck of cards may be a physical deck of cards, which may be physically shuffled. In other embodiments, the deck of cards may be a digital deck of cards, which may be electronically randomized according to algorithms known in the art.

According to the present disclosure, each deck of cards may be a standard deck of cards. Each deck of cards may comprise 52 cards, each card having one of four suits: spades; hearts; diamonds, and clubs. Each suit can contain 13 cards: Ace, two, three, four, five, six, seven, eight, nine, ten, Jack, Queen, and King. Each card can have a point value equal to its number (i.e. a “two” card has a point value of two), while each face card (e.g. Jack, Queen, and King) has a point value of ten. Each Ace may have a point value of either one or eleven.

In one embodiment, a select face card (hereinafter referred to as “Kings” for illustrative purposes only) from the standard deck (or multiple decks) are pulled from the standard deck before shuffling and the remaining cards are dealt. The number of Kings that are pulled can be equal to the number of players placing a wager during one round of play. If fewer players enter a game than there are Kings in the deck(s), then the remaining Kings are employed in the game. In another embodiment, all Kings can be pulled from the deck and reserved to be used only as the initial card given to each active player. If fewer players enter a game than there are Kings in the deck(s), then the remaining Kings are not used. In another embodiment, the Kings that belong to a standard deck remain in the deck and can be dealt with the other cards. In such embodiment, additional Kings that are not from the standard deck are used to play the game. Therefore, in such embodiment, if there are two players and the standard deck has four Kings, then the game is played with six Kings.

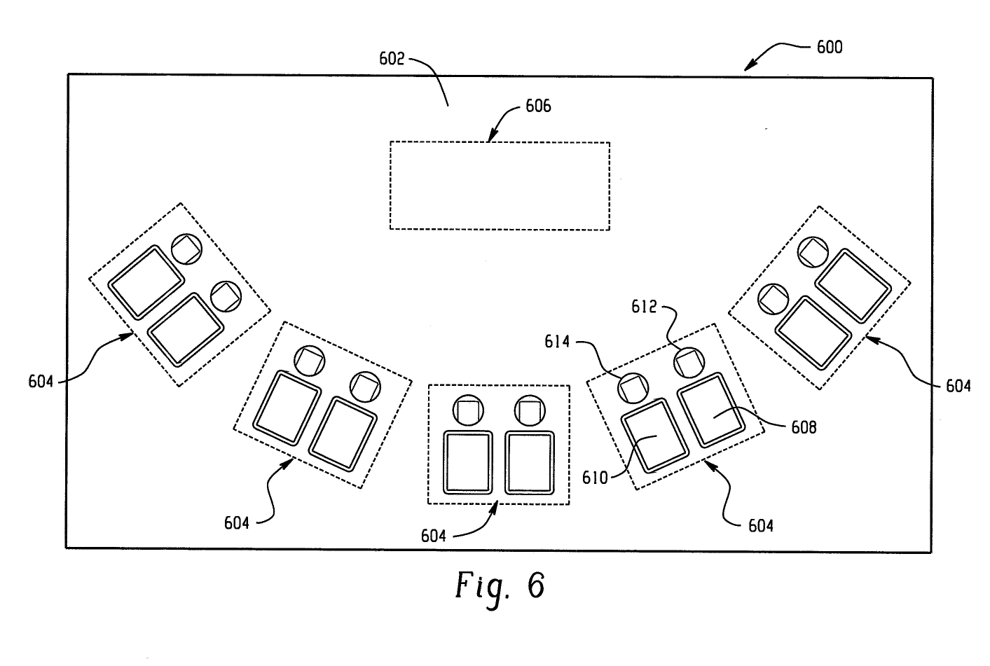

At S104, the system receives an initial bet or wager from each player of the current game. In the contemplated embodiment shown in FIG. 6, the player places a wager on a King (that is, a 10 value face card). One aspect of the present disclosure is that each player starts with an initial card guaranteeing the player ten (10) points. Each player receives a face card having a 10-point value on the table before the cards are dealt to any and all players. In the illustrative embodiment, each player receives a “King” oriented face-up at S106. The King card is provided to players as an initial “10” value. Therefore, it is important to note that any face card can be used as the initial card granted to each player entering the game. Embodiments are contemplated where a “Queen” or “Jack”, as a non-limiting example, are used.

In the illustrative embodiment, the computing device (202 or, in some embodiments 236) is treated as the “dealer”, so that a player is playing against a computer. The computer can be associated with a house (server) computer that maintains the accounting of wagers and winnings. The house can be connected to a database that allocates and reallocates monies between player computing devices.

At S108, a single card is dealt to each player from a same deck or decks. Each card may be dealt face-up for everyone to see. If multiple players are playing via a number of remote player computer devices, each connected to a dealer server computer device through a network, a console or display on any one player computer device can show the cards dealt to it and to other active players in the game. The cards can be dealt to the players in the order that they entered the game. At a gaming table, the cards can be dealt sequentially to each player, typically in a clockwise orientation.

In particular embodiments, the point value for each active player may be calculated and updated after the player's card is dealt. For example, a calculation step S110 may be performed, when individual cards are dealt to each player, or may be calculated after all cards have been dealt (discussed below). Step S110 can be performed anytime between steps S108 and S126 in the operation shown in FIGS. 2A-2B. For example, as discussed above, the player's hand(s) has an initial point total of ten at the time of his or her initial wager. Then, after each player is dealt a single card at S108, the player's hand comprises that initial card space plus the dealt card. For example, if a player placed an initial wager and is then dealt a nine card, then the point value of the face card (i.e. 10) is added to the point value of the nine card (i.e. 9) to obtain a point value/total of 19 for that hand. An ace is treated as having a point value of “11” because it would give the active player a desired total point value of 21 when combined with the given face (King) card.

Before the dealer's hand is dealt, the system provides the player(s) with the option to place a second wager. At S116, each player may optionally “double-down” by placing a second wager, wherein the second wager may be less than or equal to the original wager. Each player may elect to place or not place this second wager through a graphic user interface in communication with the dealer computing device. In particular embodiments, this second wager is placed in addition to the initial wager. The second wager does not create a second hand that may be treated separate from the initial hand. Rather, the player's second wager, if placed, increases that player's total wager placed in that game (i.e. round of the game).

In response to receiving the optional second wager (YES at S112), one additional card is dealt to the player(s) who placed the second wager at S114. In response to not receiving the second wager (i.e., the player declines the second wager option) (NO at S114), the system proceeds to deal an initial card to the dealer at S118 from the same deck(s). In the contemplated embodiment, each card dealt to the dealer may also be displayed face-up for every active player to view. At S120, a single card is added to the dealer's hand. The point total for the dealer's hand may be calculated and updated after each card is drawn from the deck(s). If the dealer was dealt an Ace, then the dealer may select whether the Ace should have a value of 1 or a value of 11. In a computerized system, treatment of the Ace value may depend on whether the dealer's point value would meet or exceed a predetermined threshold—if the Ace is treated as having a value of “11”. After the dealer is dealt each card, the point value of the dealer's hand may be calculated or displayed. In particular embodiments, if the point value of the dealer's hand is a soft 17 (i.e. the dealer's hand contains an ace with a point value of 11, and one or more other cards) (NO at S122), the operation returns to S120 and another card is dealt to the dealer. If the point value of the dealer is a hard 17 (i.e. the dealer's hand does not contain an ace with a point value of 11, and one or more other cards) (YES at S122), then the dealer may not be dealt (or draw) anymore cards. Otherwise, the dealer may be dealt additional cards—that is, one card at a time—until the point value of the dealer's hand exceeds 21 (i.e. goes bust) or the dealer chooses to stop drawing cards. In other words, the steps of S120 and S122 repeat as illustrated in FIG. 2B until the point total of the dealer's hand reaches a predetermined value or the dealer's point total exceeds 21.

After the dealer's hand is completed, the dealer's point total is calculated and updated. In response to the point total exceeding 21 (YES at S124), the dealer goes bust and the player wins. The wager is returned to the player and winnings (for example, an amount equivalent to the wager) can be allocated to the player(s) at S126. In response to the dealer's point total not exceeding 21 (NO at S124), the point value of each active hand (i.e. the hands of every player) is compared with the point value of the dealer's hand at S128 to determine whether each player wins or loses the game (round) against the dealer. If the point value of the dealer's hand is less than 22, then each player's hand with a point value higher than the dealer's hand (YES at S128) wins and the operation proceeds to S126. Each player's hand with a point value lower than the dealer's hand (NO at S128) loses (S130) and the house takes the wager. If the point value of a player's hand is equal to the point value of the dealer's hand, then the player loses (i.e. the dealer/house takes pushes). At 126 and S130, each wager is resolved. For winning players, their bet(s) are paid out at S126. For losing players, the players lose their wager at S130. In particular embodiments, all wagers pay even money (i.e. dollar for dollar). The method ends at S132.

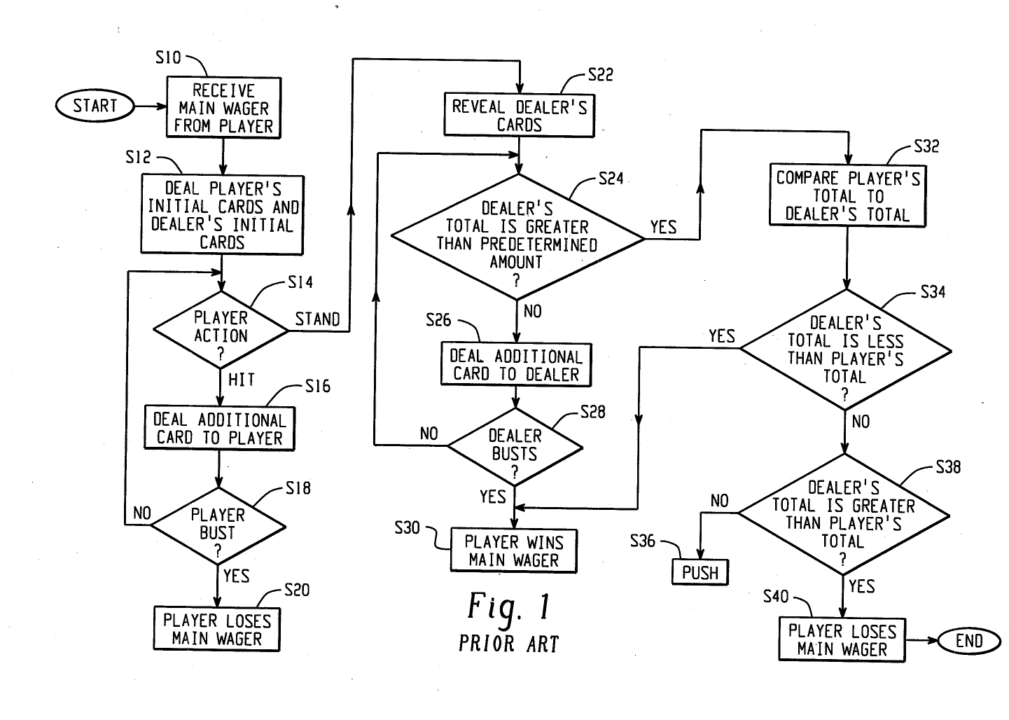

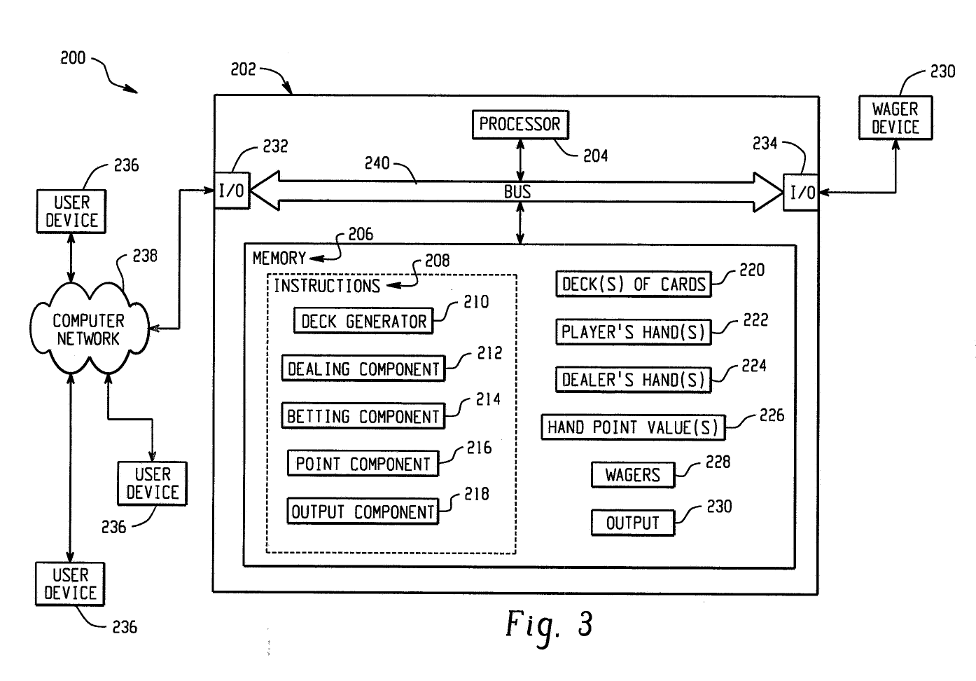

Referring now to FIG. 3, there is shown a functional block diagram of a system 200 for playing a card game in accordance with an example embodiment of the present disclosure. It will be appreciated that the various components depicted in FIG. 1 is for purposes of illustrating aspects of the exemplary hardware, software, or a combination thereof, and are capable of being substituted therein.

It will be appreciated that the system 200 of FIG. 3 is capable of implementation using a distributed computing environment, such as a computer network 238, which is representative of any distributed communications system capable of enabling the exchange of data between two or more electronic devices. It will be further appreciated that such a computer network 238 includes, for example and without limitation, a virtual local area network, a wide area network a personal area network, a local area network, the Internet, an intranet, or any suitable combination thereof. Accordingly, such a computer network 238 comprises physical layers and transport layers, as illustrated by various conventional data transport mechanisms, such as, for example and without limitation, Token-Ring, Ethernet, or other wireless or wire-based data communication mechanisms. Furthermore, while depicted in FIG. 3 as a networked set of components, the system 200 and methods discussed above are capable of implementation on a stand-alone device adapted to perform the methods previously described.

As shown in FIG. 3, the system 200 includes a one card 21 game system 202, which is capable of facilitating the implementation of the exemplary methods described above. The one card 21 system 202 may include a computer server, workstation, personal computer, laptop computer, cellular telephone, tablet computer, pager, a combination thereof, or other computing device or group of networked devices capable of executing instructions for performing the exemplary methods.

According to one example embodiment, the system 202 includes hardware, software, and/or any suitable combination thereof, configured to interact with one or more associated users, networked devices, networked storages, remote devices, user devices, or the like. The exemplary system 202 includes a processor 204, which performs the exemplary methods by execution of processing instructions 208 which are stored in memory 206 connected to the processor 204, as well as controlling the overall operation of the system 202.

The instructions 208 include a deck generator 210 that generates one or more digital decks of cards 220 as described above. The deck generator 210 may also shuffle or randomize the deck(s) of cards 220 in accordance with known methods in the art.

The instructions 208 include a dealing component 212 that creates and controls one or more players' hands 222 and a dealer's hand 224. In accordance with one embodiment, the dealing component 212 monitors active players (i.e. players currently playing) and deals cards from the one or more decks of cards 220 to each player's hand 222 and to the dealer's hand 224. The instructions 208 include a betting component 214 that receives and controls wagers 228 made by each player.

In accordance with the exemplary methods described above, the dealing component 212 and the betting component 214 work together to control the flow of each round of the game. For example, initially the betting component 214 will request a wager 228 from each active player (via user/player device(s) 236), while the dealing component 212 waits. In response to the betting component 214 receiving the wagers 228, the dealing component 212 will deal a single card to each player's hand 222 .

In particular embodiments, the dealing component 212 deals a single card to each player's hand 222 immediately after the betting component 214 receives an initial wager 228 from each player. In some embodiments, the initial wager 228 may include more than one wager 228. Then, the dealing component 212 deals cards to the dealer's hand 224 in accordance with the methods described above. Once the dealing component 212 has completed the dealer's hand 224, the dealing component 212 notifies the output component 218 that the game, or that round of the game, has been completed.

In another embodiments, referred herein as a “double-down” embodiment, the dealing component 212 deals a card to the dealer's hand 224, then the betting component 214 allows each player place a second, optional wager 228 (i.e. the double-down wager) through a console or interface. After each player has elected or declined to place an optional second wager 228, the dealing component 212 deals a single card to each player's hand 222. Then, the dealing component 212 deals additional cards to the dealer's hand 224 in accordance with the methods described above. Once the dealing component 212 has completed the dealer's hand 224, the dealing component 212 notifies the output component 218 that the game, or that round of the game, has been completed.

The instructions 208 further includes a point component 216 that monitors each player's hand 222 and the dealer's hand 224, and calculates and updates the point totals 226 of each hand 220, 222. In particular embodiments, the point component 216 may calculate and update the point totals 226 anytime a card is dealt by the dealing component 212, or after the betting component 214 receives a wager 228.

The instructions 208 also include an output component 218 that, in response to the dealer's hand 224 having been dealt, compares the point totals 226 of each player's hand 224 to the dealer's hand 224 to determine whether any player wins against the dealer. The output component 218 may determine whether a player's hand 222 wins against the dealer's hand 224 in accordance with the methods described above.

The output component 228 also generates output 230. The output 230 may include, for example, a list of winning players, losing players, winning hands, and/or losing hands, as well as the corresponding wagers 228. In cases where one or more players' hands 222 has won against the dealer's hand 224, the output component 218 determines how much those players win based on their wagers 228 and includes those amounts (i.e. the winnings) in the output 230. In cases where one or more players' hands 222 has lost against the dealer's hand 224, then the output 230 may further include a list of the losses and/or a total of the losses based on their wagers 228.

The memory 206 of the system 202 may represent any type of non-transitory computer readable medium such as random access memory (RAM), read only memory (ROM), magnetic disk or tape, optical disk, flash memory, holographic memory, and/or a combination thereof. In some embodiments, the processor 204 and memory 206 may be combined in a single chip. Network interface(s) 232, 234, discussed infra, allow the system 202 to communicate with other devices via a computer network, and may comprise a modulator/demodulator (MODEM). Memory 206 may store data processed in the method as well as the instructions for performing the exemplary method.

The digital processor 204 can be variously embodied, such as by a single core processor, a dual core processor (or more generally by a multiple core processor), a digital processor and cooperating math coprocessor, a digital controller, or the like. The processor 206, in addition to controlling the operation of the system 202, executes instructions 208 stored in memory 206 for performing the method outlined in FIGS. 2A-2B.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The system 202 also includes one or more input/output (I/O) interface devices 232 and 234 for communicating with external devices. The I/O interface 232 may communicate with, for example, one or more user/player devices 236 via a computer network 238. The various components of the system 202 may all be connected by a data/control bus 240. The processor 204 of the system 202 may be in communication with an associated network 238 via a link. A suitable communications link may include, for example, the public switched telephone network, a proprietary communications network, infrared, optical, or other suitable wired or wireless data transmission communications.

In particular embodiments, the user/player device 236 may be a computer server, workstation, personal computer, laptop computer, cellular telephone, tablet computer, pager, a combination thereof, or other computing device or group of networked devices capable of receiving input from a user and communicating with the system 202 via a computer network 238. In one embodiment, the user/player device 236 is a gaming machine or a computerized console for displaying the game.

The I/O interface 234 may also communicate with other external devices, such as a wager device 230 via a communication link as described above. A wager device 230 may include, for example, a computer server, workstation, personal computer, laptop computer, cellular telephone, tablet computer, pager, a combination thereof, or other computing device or group of networked devices capable of receiving the output 230 from the system 202 and directing the system 202 to receive or pay out wagers 228 and winnings/losses based on such wagers 228.

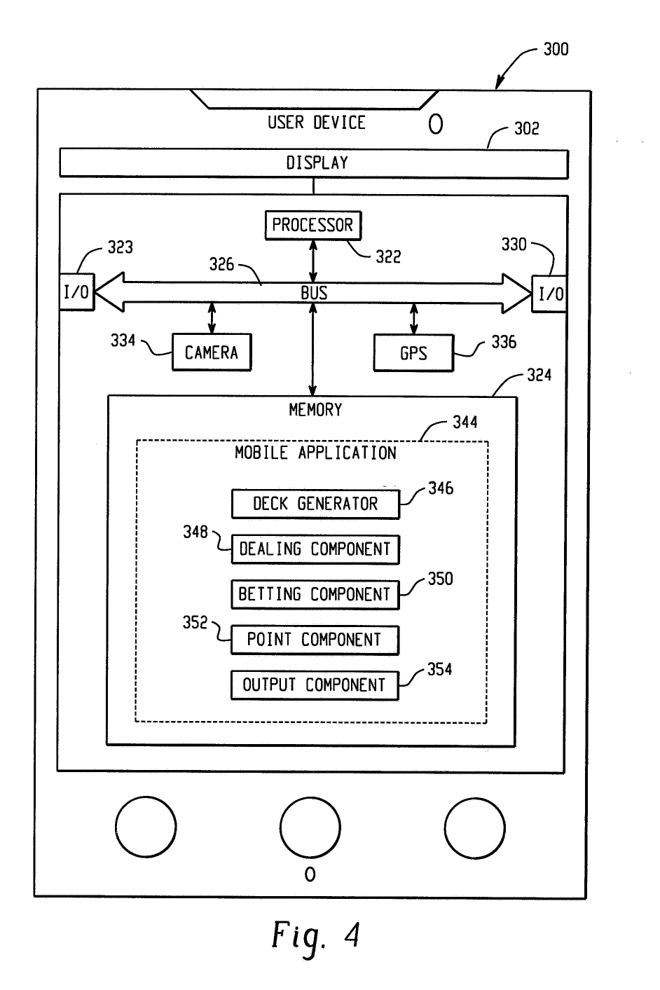

Turning now to FIG. 4, a functional block diagram illustrating one embodiment of a user device 300 (corresponding to user device 236 in FIG. 3) is shown.

The user device 300 may include a processor 322, which executes one or more instructions or applications 344 in the performance of an exemplary method discussed above. The user device 300 may further include memory 324 storing the application 344 in data communication with the processor 322 via a system bus 326. The processor 322 of the user device 300 may be in data communication with a central computer system or gaming system 202 (FIG. 3) via an I/O interface 323 or I/O interface 330. The user device 300 may further include a display 302 suitably configured to display data to an associated user (e.g., player), receive input from the associated user, and the like. In some embodiments, the display 302 of the user device 300 may be configured as a touch-screen display capable of receiving user instructions via user contact on the display, e.g., LCD, AMOLED, LED, RETINA, etc., types of touch-screen displays.

The memory 324 may represent any type of non-transitory computer readable medium such as random access memory (RAM), read only memory (ROM), magnetic disk or tape, optical disk, flash memory, or holographic memory. In one embodiment, the memory 324 comprises a combination of random access memory and read only memory. In some embodiments, the processor 322 and memory 324 may be combined in a single chip. The network interface(s) 330, 323 allow the user device 300 to communicate with other devices via a communications network, and may comprise a modulator/demodulator (MODEM). Memory 324 may store data processed in the method as well as the instructions for performing the exemplary method. The digital processor 322 can be variously embodied, such as by a single core processor, a dual core processor (or more generally by a multiple core processor), a digital processor and cooperating math coprocessor, a digital controller, or the like.

The memory 324 of the user device 300 includes the application 344 communicated from the central game system 202 during registration of the user device 300, and creation of a user account. The application 344 stored in memory 324 may be made available via a third party service, e.g., GOOGLE PLAY, ITUNES, or the like.

As shown in FIG. 3, the user devices 236 (corresponding to 300) are capable of intermittent (opportunistic) or continuous bi-directional communication with the central system 202 utilizing the I/O interface 323, 330. In one embodiment, the bi-direction communication is data communication utilizing a cellular data network, e.g., 3rd generation mobile phone standards (3G), 4th generation standards (4G, 4G LTE, WiMax), EV-DO, standalone data protocols, and the like. The user device 300 may provide account information to the central system 202 during registration therewith. The central system 202 may then register the user associated with the user device 300.

In particular embodiments, the user device 300 and the central game system 202 communicate to resolve the payment and collection of wagers.

In particular embodiments, the mobile application 344 of the user device 300 comprises a deck generator component 346, a card dealing component 348, a betting component 350, a point counter component 352, and an output component 354 as discussed with respect to FIG. 3.

In particular embodiments, the user device 300 may further comprise a camera 334 and/or a global positioning system 336.

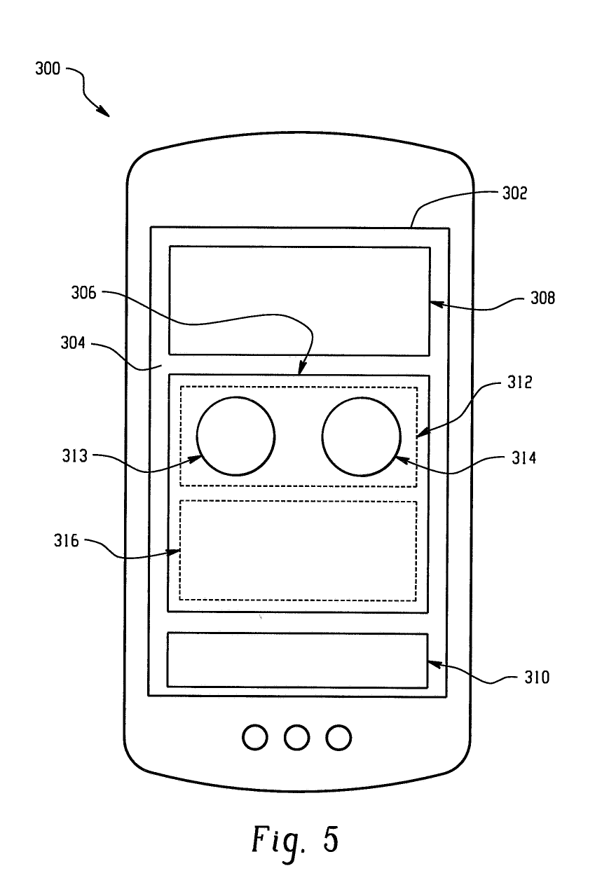

Turning now to FIG. 5, a diagram illustrating one embodiment of a user device 300 (corresponding to user device 236 in FIG. 3) is shown.

In particular embodiments, the user device 300 may comprise a processor 322 and a memory 324 in communication with the processor, wherein the memory stores instructions which are executed by the processor to: generate, on a display 302 of the user device 300, a gaming table 304; generate at least one deck of cards that is stored in the memory 324; receive and store input from a user; deal a single card from the at least one deck of cards to a user of the user device 300; deal at least one card from the at least one deck of cards to a dealer; calculate a point value for the dealer and the user; determine whether the user wins against the dealer; and communicate with an associated gaming system 202 via an input/output interface(s) 323, 330.

In other embodiments, the user device 300 may comprise a processor 322 and a memory 324 in communication with the processor 322, wherein the memory 324 stores instructions which are executed by the processor 322 to communicate with the system 202 and display on a display 302 the progression of the card game as executed by the system 202 described previously.

In particular embodiments, the user device 300 comprises a processor configured to display, on a display 302 of the user device 300, a gaming table 304 according to the methods described above. The gaming table 304 may comprise a dealer's hand region 308, wherein cards dealt to the dealer are displayed; and a player's region 306, wherein cards dealt to the player are displayed. In particular embodiments, the player's region 306 may comprise a zone 312 indicating whether the user has selected to place a wager on a King space and/or an Ace space according to the methods described above. For example, some embodiments, the zone 312 may include a King space 313, an Ace space 314, and/or a “double-down” space 412 (see FIG. 6). In particular embodiments, the display 302 may be updated to highlight or otherwise indicate whether the user has selected to place a wager on the King space 313, Ace space 314, and/or the “double-down” space 412. The player's region 306 may further comprise a card zone 316, wherein the card dealt to the user can be displayed.

The gaming table 304 may further comprise a summary or menu region 310. In particular embodiments, the region 310 may include a list of actions available to the user. In further embodiments, the region 310 may include a display of the current point values for the player and/or the dealer, a display the player's wager(s), and/or other information relevant to the game.

In particular embodiments, the user device 300 further comprises an input device (not shown). For example, in particular embodiments, the input device of the user device 300 may include a keyboard, a computer mouse, and/or a touch-sensitive screen.

With reference to FIG. 6, a physical gaming system 600 is illustrated according to one embodiment of the present disclosure. The gaming table 602 can be a physical gaming table. In one embodiment, the gaming table 602 can be displayed on a console. In one embodiment, the console is part of a computerized gaming device. The gaming table can also be an interactive gaming table displayed on a personalized user device, such as the display 304 on the mobile phone in FIG. 5. The gaming table 602 includes a plurality of player regions 604, a dealer region 606, and one or more decks of cards (not shown). In particular embodiments, the player region 604 comprises a first space 610, where the face card can be placed for active players in a face-up orientation, and a card space 608, where the single card is placed after it is dealt from a deck. In some embodiments, the player region 604 comprises a fixed rectangular imprint 608 on the felt table 402 or a visible border or outline on the computer displayed table, where the single card is subsequently dealt. Associated with and generally adjacent to each rectangular space 608 is a face card space 610. In accordance with the methods described above, the player may place his wager on one of the token areas 410 or 412, according to a house rule. A first designated token area 410 is shown for illustrative purposes and allows a player to place his initial wager to enter the game, that is prior to any cards being dealt. In one embodiment, a second designated token area 408 can be included on the table for allowing the player to place its optional second wager in the double-down embodiment. In particular embodiments, the player's optional second wager is placed after the player has drawn a first card but before the dealer has been dealt any cards. Of course, the location of the designated wager areas is not limited to any one location. Additionally, embodiments are contemplated with only one wager area, where the optional second wager can be placed on top of the initial wager. In particular embodiments, the gaming table 502 comprises at least two player regions 604. In specific embodiments, the gaming table 502 comprises six player regions (not shown).

In particular embodiments, all cards dealt during the game are dealt face-up for each player and the dealer to see.

One aspect of the disclosure is that a player can never go bust if it does not option for a second wager, so the card game is user-friendly for players that are not skilled at making decisions or are not quick on their feet when making decisions. In other words, the card game of the present disclosure can be played by a wider range of players—such as those players that do not desire to make decisions on each card, which is required in the traditional Blackjack game. At the same time, the card game of the present disclosure offers a player the option for a second wager if, for example, the single card dealt to the player is a low value card, such as a “2” or “3”, and where the total point value of the player's hand is low, such as “12” or “13” after being dealt such single card.

Another aspect of the disclosed game is that it allows for more hands to be played per hour compared to standard Blackjack. By issuing no more than 2 cards from a deck to each player, the hands can be dealt faster. Additionally, the time delay that may result by players contemplating each move in the standard Blackjack game is reduced, especially for novices. In the contemplated physical embodiment of the card game, it is anticipated that dealers can deal about 90 hands an hour, depending on how the deck is shuffled.

Another aspect of the disclosed game system is that it provides a card game that gives a house or dealer an improved house edge, thus providing the house with a greater advantage over standard Blackjack games. In one contemplated embodiment, the card game disclosed herein has about a 2.23% house edge.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. Computer code on a non-transitory computer readable medium for use in a computer for facilitating a method of playing a card game, comprising:
in response to receiving a wager in the form of input, dealing a player's hand including a card having a value of 10 and a single card having a corresponding number value corresponding with the single card in a standard deck;
after dealing the player's hand, dealing at least two cards against the player's hand, the at least two cards being dealt from among cards remaining in at least one standard deck;
comparing a total point value of the at least two cards to a predetermined threshold;
in response to the total point value of the at least two cards meeting or exceeding the predetermined threshold, comparing the total point value of the at least two cards to a total point value of the player's hand;
in response to the total point value of the at least two cards being greater than the total point value of the player's hand, reallocating an amount corresponding to the wager to an account associated with the computer; and
in response to the total point value of the at least two cards being less than the total point value of the player's hand, providing a payout in the form of output.

2. The method of claim 1 further comprising:
in response to the total point value of the at least two cards being greater than the total point value of the player's hand, reimbursing the wager in the form of output.

3. The method of claim 1, wherein the card having the value of 10 is a face card.

4. The method of claim 3, wherein the face card is a king.

5. The method of claim 1, wherein the wager is received via an interactive console in communication with the computer, and the wager corresponds to a player account.

6. The method of claim 1, wherein the computer is selected from the group consisting:
a computer server;
an electronic gaming machine;
a workstation;
a personal computer;
a laptop computer;
a mobile device;
a tablet computer; and
a combination of the above.

7. The method of claim 1 further comprising:
after randomly dealing the player's hand, providing an option for an additional wager; and
in response to receiving the additional wager as a form of input; adding a third card to the player's hand from the at least one deck.

8. The method of claim 1, wherein the wager is received via a graphic user interface in communication with the computer.

9. The method of claim 1, wherein the method provides a house-edge of 2.23%.

10. The method of claim 1, wherein each card dealt from the at least one deck is displayed face-up on a console in communication with the computer.

11. A computer gaming system for facilitating the playing of a card game, comprising:
a processor; and
a non-transitory computer readable memory storing instructions that are executable by the processor to:
in response to receiving a wager in the form of input, deal a player's hand including a face card and one card having a corresponding point value corresponding to the one card in a standard deck;
after dealing the player's hand, deal two cards against the player's hand from among cards remaining in at least one standard deck;
compare a total point value of the at least two cards to a predetermined threshold;
in response to the total point value meeting or exceeding the predetermined threshold, compare the total point value of the at least two cards to a total point value of the player's hand;
in response to the total point value of the at least two cards being greater than the total point value of the player's hand, reallocate an amount corresponding to the wager to an account associated with the computer; and
in response to the total point value of the at least two cards being less than the total point value of the player's hand, provide a payout in the form of output.

12. The system of claim 11, wherein the processor is part of a computer server;
wherein the system further comprises at least one remote gaming machine in communication with the server.

13. The system of claim 11, wherein the processor is further operative to:
in response to the total point value of the user's hand being greater than the total point value of the player's hand, return the wager to the user.

14. The system of claim 11 further comprising:
an interactive console in communication with the processor for receiving the wager.

15. The system of claim 11, wherein the processor is implemented in a computer selected from the group consisting of:
a computer server;
an electronic gaming machine;
a workstation;
a personal computer;
a laptop computer;
a mobile device;
a tablet computer; and
a combination of the above

16. The system of claim 11, wherein the processor is further operative to:
after dealing the player's hand, providing the associated player with an option to place an additional wager; and
in response to receiving the additional wager; adding a third card to the player's hand from the standard deck.

17. The system of claim 11 further comprising:
a graphic user interface in communication with the computer, the graphic user interface for receiving the wager.

18. The system of claim 11, providing the user with a house-edge of about 2.23%.

19. The system of claim 11 further comprising:
an output device in communication with the processor, wherein in response to the player having an amount allocated to it in the memory, the processor is operative to generate an output corresponding to a payout for the amount to a player and transmit the output to the output device.

20. The system of claim 11, further comprising:
a console in communication with the processor, the console displaying each card dealt from the at least one deck of cards in a face-up orientation.
